(19) United States
(12) Patent Application Publication
(10) Pub. No.: US 2012/0323918 A1
(43) Pub. Date: Dec. 20, 2012

(54) METHOD AND SYSTEM FOR DOCUMENT CLUSTERING

(75) Inventors: Ju Wei Shi, Beijing (CN); Wen Jie Wang, Shanghai (CN); Wei Xue, Beijing (CN); Bo Yang, Beijing (CN)

(73) Assignee: International Business Machines Corporation, Armonk, NY (US)

(21) Appl. No.: 13/599,158

(22) Filed: Aug. 30, 2012

Related U.S. Application Data
(63) Continuation of application No. 13/517,684, filed on Jun. 14, 2012.

(30) Foreign Application Priority Data
Jun. 14, 2011 (CN) 201110160101.1

(51) Int. Cl. G06F 17/30

(52) U.S. Cl. 707/737; 707/E17.089

(57) ABSTRACT

A method and system for document clustering. The method includes: extracting text feature information of the documents, establish a social network based on information related with the documents, performing graph clustering based on the social network to obtain structural sub-set, extracting structural feature information of the structural sub-set, and performing clustering on the documents based on the text feature information and the structural feature information.

### CROSS REFERENCE TO RELATED APPLICATION

This application is a continuation of and claims priority from U.S. patent application Ser. No. 13/517,684, filed Jun. 14, 2012, which in turn claims priority under 35 U.S.C. 119 from Chinese Application 201110160101.1, filed Jun. 14, 2011, the entire contents of both are incorporated herein by reference.

### BACKGROUND OF THE INVENTION

1. Field of the Invention

The invention generally relates to the information processing technology field, and in particular, to a method and system for document clustering.

2. Description of the Related Art

With the popularity of the internet, massive amounts of text information provide rich data sources for text analysis. With the analysis of text data, information such as a public hotspot can be detected. With respect to text analysis technology, clustering is the key step for many applications, and an effective text clustering method can enhance the accuracy of public hotspot recognition.

Traditional text clustering technology generally extracts text feature information of documents, such as keyword frequency, and then calculates a similarity between two documents based on the text feature information, and then performs clustering based on the similarity. However, this kind of clustering algorithm has limitations because it only considers the similarity of the contents of the documents, and an accurate analysis cannot be performed on relationship between the documents whose contents are not irrelative. Thus, it is necessary to provide an improved method and system for document clustering.

### BRIEF SUMMARY OF THE INVENTION

In order to overcome these deficiencies, the present invention provides a method for document clustering, including: extracting text feature information of documents; establishing a social network based on information related with the documents; performing graph clustering based on the social network, to obtain a structural sub-set; extracting structural feature information of the structural sub-set; and performing clustering on the documents based on the text feature information and the structural feature information.

According to another aspect, the present invention provides a system for document clustering, including: text feature information extracting means, for extracting text feature information of documents; social network establishing means, for establishing a social network based on information related with the documents; graph clustering means, for performing graph clustering based on the social network, to obtain structural sub-set; structural feature information extracting means, for extracting structural feature information of the structural sub-set; and clustering means, for performing clustering on the documents based on the text feature information and the structural feature information.

### BRIEF DESCRIPTION OF THE SEVERAL VIEWS OF THE DRAWINGS

The features and advantages of the embodiments of the invention will be explained with reference to the appended drawings. If possible, the same or like reference number denotes the same or like component in the drawings and the description. In the drawings:

FIG. 1 shows a first embodiment of the invention for document clustering;

FIG. 2 shows a second embodiment of the invention for document clustering;

FIG. 3 shows the second embodiment of the invention for document clustering;

FIG. 4 shows a schematic diagram of a social network established by using documents as nodes;

FIG. 5 shows a structural schematic diagram of a system of the invention for document clustering; and

FIG. 6 illustratively shows a structural block diagram of a computing device able to realize the embodiments of the invention.

### DETAILED DESCRIPTION OF THE PREFERRED EMBODIMENTS

Below, embodiments of the invention will be described in detail with reference to the drawings in which the embodiments of the invention are illustrated, and like reference numbers always indicate the same element. It should be understood that the invention is not limited to the disclosed embodiments. It should also be understood that not every feature of the method and apparatus is necessary for implementing the invention to be protected by any claim. In addition, in the whole disclosure, when displaying or describing the process or the method, the steps of the method can be executed in any order or simultaneously, unless it is clear from the context that one step depends on another previously-executed step. In addition, there may be prominent time intervals between the steps.

When researching how to analyze the relationship between documents more accurately by using a document clustering method, it was found, with the rapid development of network applications such as the weblog, that the social relationship structural information between authors of documents can be used as an important factor in document clustering. With the interactive relationship network between authors of the documents, the similarity of the authors of two documents can be recognized, so as to enhance the accuracy of the document clustering. Taking documents on the network as an example, the interactive relationship between the authors of documents may include posted replies to the documents, messages, co-authorship of the documents, and so on.

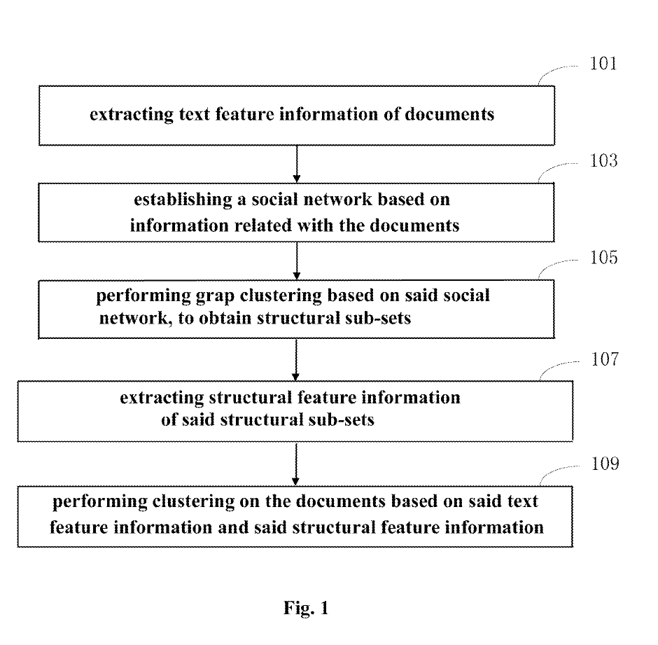

FIG. 1 shows a first embodiment of the invention for document clustering. At step 101, text feature information of documents is extracted. A person skilled in the art can use various suitable methods for extracting the feature information of the documents based on the present application. For example, a TFIDF algorithm (Term-Frequency Inverse Document Frequency Algorithm) can be used to extract features from documents (see, e.g., J. Allan, J. Carbonell, G. Doddington, J. Yamron and Y. Yang. “Topic detection and tracking pilot study: Final report”. In Proc. of DARPA Broadcast News Transcription and Understanding Workshop, 1998). First, each document is divided into words. For example, the document content “. . . data analysis is a core technology for a network company” will be divided into “data analysis/is/a/core/technology/for/a/network/company.” For the result of the division, conjunction words and stop words are filtered out, and it is obtained as “data analysis/core technology/network/company,” and then the remaining words are used as an input to a word frequency table. For all the documents to be processed, the word frequency table is established, the occurrence number of each word is statistically calculated, and the words with a medium frequency are selected to establish an index word library. The frequency in which a word in the index word library occurs in each document is statistically calculated to obtain a frequency vector, and then according to the definition of the TFIDF algorithm, the feature vector of each word is calculated, and the feature vector is used as the text feature information. For example, the feature vector of the above words “data analysis/network/core technology” is calculated as { log ⅔, 0, 0}, and the text feature information Tᵢ of the document is { log ⅔, 0, 0}, wherein, i is an integer, for calculating the similarity between the subsequent documents. Since there are many existing technologies for extracting text feature information of documents, their description is omitted here.

At step 103, a social network is established based on information related with the documents. The information related with the documents can include authors of the documents, the replies between the authors of the documents, the co-authors of the documents or the relationship of messages on blogs between the authors, the relationship of reposted topics between the authors, and so on. The aim of constructing the social network of the documents is to be able to analyze the social structure of the authors of the documents, thereby going beyond only discovering the associations between the documents based on their contents, facilitating more accurate document clustering.

At step 105, clustering is performed based on the social network to obtain a structural sub-set. The structural sub-set is a collection of nodes belonging to the same set, which is obtained with a graph clustering algorithm based on the social network. A person skilled in the art can use a common graph clustering algorithm based on the application to perform clustering on the social network. See, e.g., Y. Zhang, J. Wang, Y. Wang, and L. Zhou, “Parallel community detection on large networks with propinquity dynamics,” in Proceedings of the 15th ACM SIGKDD international conference on Knowledge discovery and data mining. ACM, 2009, pp. 997-1006; M. E. J. Newman and M. Girvan, “Finding and evaluating community structure in networks,” Physical review E, vol. 69, no. 2, pp. 26113, 2004.

At step 107, structural feature information of the structural sub-set is extracted. The structural feature information can include at least one of: the number of sub-set members, the membership of the structural sub-set member (adscription), and the density of the structural sub-set. The sub-set member number is the number of the members in a structural sub-set. The structural sub-set member adscription means whether the members belong to this sub-set, and normally, it is necessary to determine whether two members belong to the same structural sub-set. The structural sub-set density degree means the tightness of the degree of the associations between a member in the structural sub-set and other members in the sub-set. This structural feature information represents the social association degree between the respective nodes in the social network, and can be used to facilitate the document clustering. Of course, a person skilled in the art may select other suitable structural feature information based on the present application to represent the social association degree between respective nodes in the social network.

At step 109, clustering is performed on the documents based on the structural feature information and the text feature information. Similarity between the documents can be calculated based on the text feature information and the structural feature information. After obtaining the similarity between the respective documents, clustering can be further performed on the respective documents with a clustering algorithm, based on the similarity between the respective documents. A person skilled in the art can, based on the present application, using the obtained similarity between the documents as an input, use common clustering algorithms known in the art, such as KMeans clustering algorithm, K-MEDOIDS algorithm, a CLARANS algorithm, and so on, to perform clustering on the respective documents. After the related clustering algorithm is utilized, more effective document clustering can be obtained, compared to traditional clustering methods based on text features, the internal structure between the documents can be preferably analyzed, and the accuracy of the text clustering enhanced.

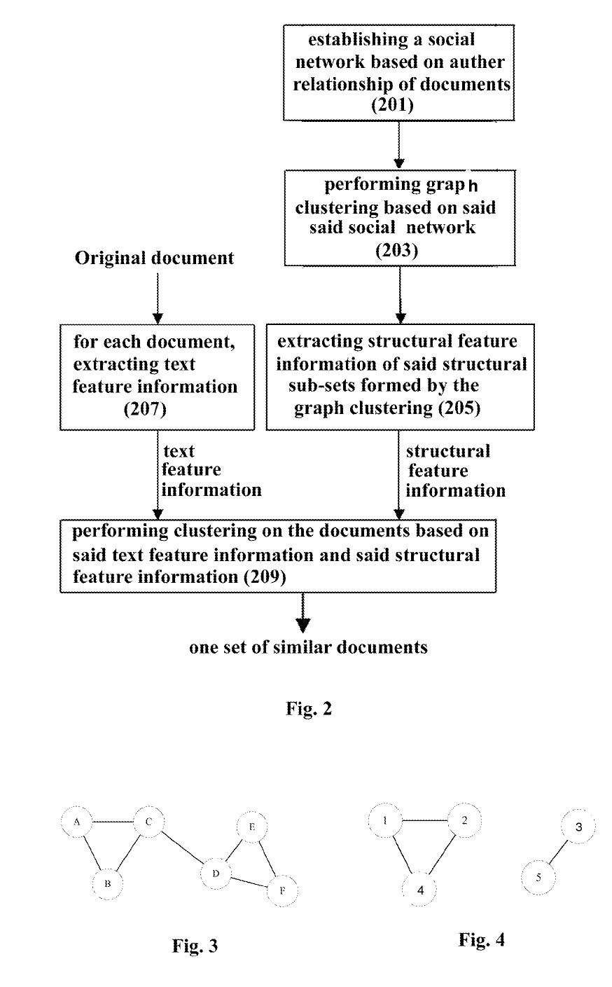

FIG. 2 and FIG. 3 show a second embodiment of the invention for document clustering. The second embodiment will be explained in combination with a particular example herein. At step 201, a social network is established based on information related with the documents. Based on the relationship between the authors of the documents, taking the authors as nodes, and taking the interactive relationships between the authors as lines, the social network is constructed. In this embodiment, assume original data is shown as Table 1 below. The original data can be saved as information related with the documents, and can be used in the subsequent document clustering. It is to be noted that, the interactive associations between the documents are obtained not only by using the authors and the replying authors as the related information of the documents herein, but also by using other related information of other aspects.

TABLE 1

| Document | | Document | | |
|---|---|---|---|---|
| No. | Document title | content | Author | Reply author |
| 1 | . . . | . . . | A | B, C |
| 2 | . . . | . . . | B | A, C |
| 3 | . . . | . . . | C | D, B, F |
| 4 | . . . | . . . | A | B |
| 5 | . . . | . . . | D | C, B, E, F |
| 6 | . . . | . . . | E | A, C, D, F |
| 7 | . . . | . . . | F | D, E |
| . . . | . . . | . . . | . . . | . . . |

From Table 1, the interactive reply relationships between the authors can be obtained as shown in Table 2 below. The middle portion represents the replied document. If A replies to the document 1 of B, then the document 1 will occur both in A, B as well as B, A.

TABLE 2

| Author | | | | | | |
|---|---|---|---|---|---|---|
| No. | A | B | C | D | E | F |
| A | — | 1, 2, 4 | 1, 2 | 4 | 6 | 4 |
| B | 1, 2, 4 | — | 2, 3 | 5 | — | — |
| C | 1, 2 | 2, 3 | — | 3, 5 | 6 | 3 |
| D | 4 | 5 | 3, 5 | — | 5, 6 | 5, 7 |
| E | 6 | — | 6 | 5, 6 | — | 6, 7 |
| F | 4 | — | 3 | 5, 7 | 6, 7 | — |

It can be specified that if the interactive replies between the two authors of the documents are two or more, one line can be established, and of course, a person skilled in the art may set a related reply threshold correspondingly according to particular conditions to decide whether to establish a line between the related authors, so as to obtain a corresponding adjacent list as shown in Table 3 below. The adjacent table can be represented as a graph as shown in Table 3, and after the graph representing the social associations of the documents is obtained, the graph clustering step can be performed as below.

TABLE 3

| | |
|---|---|
| A | B, C |
| B | A, C |
| C | A, B, D |
| D | C, E, F |
| E | D, F |
| F | D, E |

At step 203, for the established social network (note: this is a widely-used social network. The nodes can be human or other entities such as the documents or otherwise), the above existing graph clustering technology is used to perform graph clustering. By using the graph clustering technology, structural sub-sets are divided out. For example, two structural sub-sets {A, B, C} and {D, E, F} can be obtained.

At step 205, structural feature information of the sub-set formed by the graph clustering is extracted. For each structural sub-set obtained by the graph clustering, structural information is extracted, such as the number of sub-set members, membership of the structural sub-set members (adscription), the density of structural sub-sets, and so on. This structural feature information will be used as an input to the next document clustering, so as to affect the result of the clustering, and effectively enhance the accuracy of the document clustering. Using the graph clustering algorithm, a collection of one set of nodes is obtained as a structural set. The structural sub-set member adscription means whether two members are grouped into the same sub-set. The structural sub-set tightness degree can be designed as the degree of the nodes to be connected to the sub-set divided by a total degree. A person skilled in the art might refer to the association degree between one node and another in the network data as a degree. Illustratively, if one node has associations with other 5 nodes, it can be considered that the node V1 has a degree of 5 in the network data. The structural sub-set density degree represents the tightness degree of the associations of internal members of the discovered structural sub-set. As FIG. 3 shows, if the node {A, B, C} is grouped into a structural sub-set, and the node {D, E, F} is grouped into a structural sub-set, then the density of the sub-set {A, B, C} is 6/7, because the sub-set contains 6 degrees to point to this sub-set itself, and 1 degree to point to other sub-set (the degree of the node C to point to the node D). When the authors of the two documents do not belong to the same structural sub-set, i.e., the structural sub-set member adscription is 0 and the structural sub-set tightness degree is 0.

At step 207, for each document, the text feature information is extracted. The method for extracting the text feature information as mentioned above can be utilized, to extract features from the document subjected to word segmentation, so as to obtain the text feature information of each document.

At step 209, based on the structural feature information and the text feature information, clustering is performed on the documents. For two documents with the authors belonging to the same structural sub-set, the similarity between the documents is increased when clustering. Thus, the clustering not only considers the feature of the text, but also considers the feature of the social relationship structure, so as to enhance the accuracy of the clustering. This will be explained in further detail in the following embodiments.

In an embodiment of the text analysis, two documents M1 and M2 correspond to authors V1 and V2, respectively. The TFIDF feature vectors of M1 and M2 are T1 and T2, and the member structural sub-set adscription value of V1 and V2 is C(V1, V2), and when authors V1 and V2 are in the same discovered structural sub-set, C(V1, V2)=1, otherwise, C(V1, V2)=0. In addition, when C(V1, V2)=1, D(V1, V2) indicates the tightness degree of the structural sub-set, and when C(V1, V2)=0, D(V1, V2)=0. The similarity value S(M1, M2) of the two documents can be represented as formula 1:

$$S ( {M}_{1} , {M}_{2} ) = α \frac{{T}_{1} \cdot {T}_{2}}{\vert {T}_{1} \vert \times \vert {T}_{2} \vert} + β \cdot C ( {v}_{1} , {v}_{2} ) \cdot D ( {v}_{1} , {v}_{2} ) \qquad ( 1 )$$

α and β are the weights for estimating the similarity of the two documents for the document text feature and the structural feature, respectively, where αand β are both greater than 0, and α+β=1. According to the obtained similarity S(Mᵢ, Mⱼ) between the respective documents and each other, i and j are the sequential numbers of the documents, and the clustering can be performed on all of the documents, for example by KMeans clustering, so as to obtain documents belonging to the same set.

It is to be noted that, when calculating the similarity S(M1, M2), it is necessary to also consider the effects of the text feature

$$\frac{{T}_{1} \cdot {T}_{2}}{\vert {T}_{1} \vert \times \vert {T}_{2} \vert}$$

and the structural feature C(v₁,v₂),D(v₁,v₂). Use of particular similarity calculating methods are not limited to the formula (1), but also can be shown as formula (2). A person skilled in the art, based on the present application, can indeed contemplate even more calculating methods.

$$S ( {M}_{1} , {M}_{2} ) = \frac{{T}_{1} \cdot {T}_{2}}{\vert {T}_{1} \vert \times \vert {T}_{2} \vert} \cdot \frac{1 + C ( {v}_{1} , {v}_{2} ) \cdot D ( {v}_{1} , {v}_{2} )}{2} \qquad ( 2 )$$

In addition, as a third embodiment of the invention, the documents themselves can be used as nodes, the interactive relationship between the authors of the documents are still used as lines, and the social network of the documents is established to analyze the association relationships between the documents. Another example of a method for using documents as nodes to establish the social network of the documents will be described below. Assume original data is shown in Table 4 below.

TABLE 4

| Document | Document | Document | | |
|---|---|---|---|---|
| No. | title | content | Author | Reply author |
| 1 | . . . | . . . | A | B, C |
| 2 | . . . | . . . | B | A, C |
| 3 | . . . | . . . | C | D |
| 4 | . . . | . . . | A | B |
| 5 | . . . | . . . | D | C |
| . . . | . . . | . . . | . . . | . . . |

From the above original data, the same author between the documents can be obtained as shown in Table 5, where the middle represents the same author between the documents out of all of the posting and replying authors.

TABLE 5

| Document No. | 1 | 2 | 3 | 4 | 5 |
|---|---|---|---|---|---|
| 1 | — | A, B, C | C | A, B | C |
| 2 | A, B, C | — | C | A, B | C |
| 3 | C | C | — | | C, D |
| 4 | A, B | A, B | | — | |
| 5 | C | C | C, D | | — |

Assume if the number of the same author of two documents (including the posting author and the replying author) is two or larger, one line is established, and an adjacent list with documents as nodes can be obtained as shown in Table 6. Its social network is shown as FIG. 4.

TABLE 6

| | |
|---|---|
| 1 | 2, 4 |
| 2 | 1, 4 |
| 3 | 5 |
| 4 | 1, 2 |
| 5 | 3 |

Based on the social network established as above, a person skilled in the art may refer to the second embodiment to obtain a method for document clustering based on the social network of the document nodes; a description of that is omitted here.

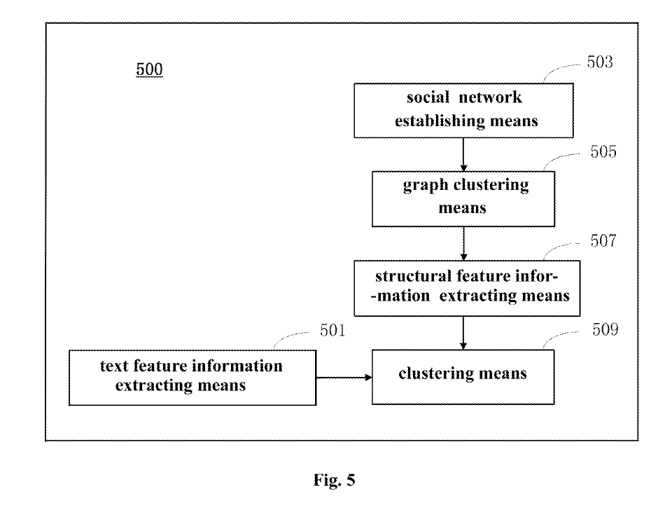

Another embodiment of the invention is to provide a system for document clustering. As shown in FIG. 5, the system 500 for document clustering includes: text feature information extracting means 501 for extracting text feature information of documents; social network establishing means 503 for establishing a social network based on information related with the documents; graph clustering means 505 for performing graph clustering based on the social network, to obtain a structural sub-set; structural feature information extracting means 507 for extracting structural feature information of the structural sub-set; and clustering means 509 for performing clustering on the documents based on the text feature information and the structural feature information.

In another aspect, the clustering means 509 includes: similarity calculating means, for calculating a similarity between the documents based on the text feature information and the structural feature information.

In another aspect, the clustering means 509 further includes: document clustering means, for performing clustering on respective documents with a clustering algorithm, based on the similarity between the respective documents.

In another aspect, the structural feature information includes at least one of: number of sub-set members, the membership of the structural sub-set member (adscription), and the density of the structural sub-set.

In another aspect, the nodes of the social network are authors of the documents, and the lines between the nodes are interactive relationships between the authors of the documents.

In another aspect, the nodes of the social network are the documents, and the lines between the nodes are interactive relationships between the authors of the documents.

In another aspect, the information related with the documents includes the authors of the documents and the interactive relationships between the authors of the documents.

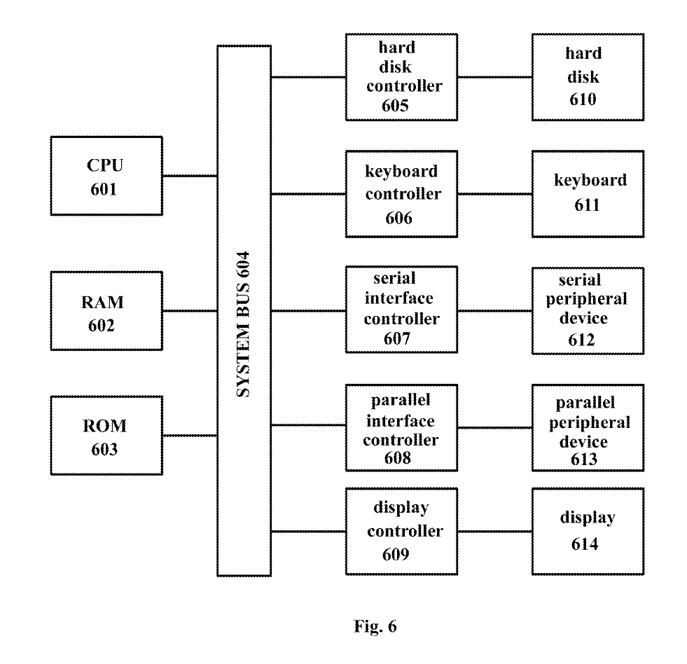

FIG. 6 illustratively shows a structural block diagram of a computing device able to realize the embodiments of the invention. The computer system as shown in FIG. 6 includes CPU (central processing unit) 601, RAM (random access memory) 602, ROM (Read Only Memory) 603, system bus 604, hard disk controller 605, keyboard controller 606, serial interface controller 607, parallel interface controller 608, display controller 609, hard disk 610, keyboard 611, serial peripheral device 612, parallel peripheral device 613 and display 614. In these components, coupled with the system bus 604 are the CPU 601, the RAM 602, the ROM 603, the hard disk controller 605, the keyboard controller 606, the serial interface controller 607, the parallel interface controller 608 and the display controller 609. The hard disk 610 is coupled with the hard disk controller 605, the keyboard 611 is coupled with the keyboard controller 606, the serial peripheral device 612 is coupled with the serial interface controller 607, the parallel peripheral device 613 is coupled with the parallel interface controller 608, and the display 614 is coupled with the display controller 609.

The function of each component in FIG. 6 is well-known in the technical art, and the structure as shown in FIG. 6 is a general one. This structure is applicable not only to personal computers, but also to handheld devices such as Palm PCs, PDAs (Personal Data Assistant), mobile phones and so on. In different applications, for example, when realizing a user terminal including the client end module according to the invention or the server host including the network application server according to the invention, some components can be added into the structure as shown in FIG. 6, or some components can be omitted from FIG. 6. The whole system as shown in FIG. 6 can be controlled by computer readable instructions stored in the hard disk 610, EPROMs or other non-volatile storages as software. The software can be downloaded from the network (not shown in the figure), or stored in the hard disk 610, or the downloaded software from the network can be loaded into the RAM 602, and executed by the CPU 601, to complete the functions determined by the software.

Although the computer system described in FIG. 6 can support the solutions provided by the invention, the computer system is only an example of the computer systems. A person skilled in the art will understand that many other computer system designs can realize the embodiments of the invention.

Although embodiments of the invention are described here with reference to the accompanying drawings, it should be understood that the invention is not limited to these precise embodiments, and a person skilled in the art may make various modifications to the embodiments without departing from the scope and the principle of the invention. All such variations and modifications are intended to be contained in the scope of the invention as defined by the appended claims.

A person skilled in the art will know that the invention may be embodied as a system, a method or a computer program product. Thus, the invention can be implemented in particular in following forms, including: a whole hardware, a whole software (including firmware, residing software, microcode), or a combination of software parts and hardware parts. In addition, the invention can also adopt the form of computer program product in any medium of expression, with computer-usable non-transient program codes included in the medium.

Any combination of one or more computer-usable or computer-readable mediums can be used. The computer-usable or computer-readable mediums can be, but are not limited to, for example, electric, magnetic, optic, electro-magnetic, infrared, or semiconductor system, apparatus, device, and transmission medium. More particular examples of computer-readable mediums include: electric connection with one or more wires, portable computer disk, hard disk, Random Access Memory (RAM), Read Only Memory (ROM), Erasable Programmable Read Only Memory (EPROM or flash memory), optical fiber, portable Compact Disk Read Only Memory (CD-ROM), optical storage device, such as a transmission medium supporting Internet or Intranet, and a magnetic storage device. It should be appreciated that, the computer-usable or computer-readable mediums can even be papers or other suitable mediums with programs printed thereon, because such paper or other mediums can be, for example, electronically scanned to electronically obtain the program, and then compiled, interpreted or processed in a suitable manner, and stored in a computer memory as necessary. In the context of this document, the computer-usable or computer-readable medium can be any medium for containing, storing, transferring, transporting, or transmitting programs to be used by an instruction execution system, apparatus or device, or to be associated with the instruction execution system, apparatus or device. The computer-usable medium can include a data signal embodying the computer-usable non-transient program code, transmitted in the base band or as a part of the carrier. The computer-usable non-transient program code can be transmitted by any suitable medium, including, but not limited to, wireless, wired, cable, RF and so on.

The computer-usable non-transient program codes for performing the operations of the invention can be composed in any combination of one or more programming languages, including Object-Oriented programming languages, such as Java, Smalltalk, C++ and so on, and normal process programming languages, such as “C” programming language or like programming languages. The program codes can be executed entirely on the user's computer, partially on the user's computer, as one independent software package, partially on the user's computer and partially on a remote computer, or entirely on the remote computer or a web server. In the latter case, the remote computer can be connected to the user's computer by any type of network, including Local Area Network (LAN) or Wide Area Network (WAN), or to external computers (for example by an Internet web service provider using Internet).

In addition, each block of the flowchart and/or block diagram, and the combinations of blocks in the flowchart and/or block diagram of the invention can be realized by computer program instructions, which can be provided to processors of general computers, dedicated computers or other programmable data processing apparatus to produce one machine to enable generating of the means for the functions/operations prescribed in blocks in the flowchart and/or block diagram by these instructions executed by the computers or other programmable data processing apparatus.

These computer program instructions can also be stored in computer-readable mediums capable of instructing computers or other programmable data processing apparatus to operate in a particular manner. Thus, the instructions stored in the computer-readable medium generate instruction means for realizing the functions/operations prescribed in blocks in the flowchart and/or block diagram. The computer program instructions can also be loaded into a computer or other programmable data processing apparatus to enable the computer or other programmable data processing apparatus to execute a series of operation steps, to generate the process realized by the computer, thereby providing a process for realizing the functions/operations prescribed in blocks in the flowchart and/or block diagram in the instructions executed on the computer or other programmable apparatus.

The flowcharts and the block diagrams in the drawings illustrate the possible architecture, the functions and the operations of the system, the method and the computer program product according to embodiments of the invention. In this regard, each block in the flowcharts or block diagrams may represent a portion of a module, a program segment or a code, and the portion of the module, program segment, or code includes one or more executable instructions for implementing the defined logical functions. It should also be noted that in some alternative implementations, the functions labeled in the blocks may occur in an order different from the order labeled in the drawings. For example, two sequentially shown blocks can be substantially executed in parallel, and they sometimes can also be executed in a reverse order, which is defined by the referred functions. It also should be also noted that, each block in the flowcharts and/or the block diagrams and the combination of the blocks in the flowcharts and/or the block diagrams can be implemented by a dedicated system based on hardware for executing the defined functions or operations, or can be implemented by a combination of dedicated hardware and computer instructions.

What is claimed is:

1. A system for document clustering, comprising:
text feature information extracting means, for extracting text feature information of documents;
social network establishing means, for establishing a social network based on information related with said documents;
graph clustering means, for performing graph clustering based on said social network, to obtain structural sub-set;
structural feature information extracting means, for extracting structural feature information of said structural sub-set; and
clustering means, for performing clustering on said documents based on said text feature information and said structural feature information.

2. The system according to claim 1, wherein said clustering means comprise:
similarity calculating means, for calculating similarity between said documents based on said text feature information and said structural feature information.

3. The system according to claim 2, wherein said clustering means comprise:
document clustering means, for performing clustering on respective documents with a clustering algorithm, based on said similarity between said respective documents.

4. The system according to claim 1, wherein said structural feature information includes at least one of: a number of sub-set members, a membership of said structural sub-set member, and a density of said structural sub-set.

5. The system according to claim 1, wherein:
said structural sub-set comprises a collection of nodes belonging to the same set; and
said nodes of said social network are authors of said documents, and lines between said nodes are interactive relationships between said authors of said documents.

6. The system according to claim 1, wherein:
said structural sub-set comprises a collection of nodes belonging to the same set; and
said nodes of said social network are said documents, and lines between said nodes are interactive relationships between said authors of said documents.

7. The system according to claim 1, wherein said information related with said documents comprises authors of said documents and interactive relationships between said authors of said documents.

8. The system according to claim 1, wherein said structural sub-sets are a collection of nodes belonging to the same set, obtained with a graph clustering algorithm based on said social network.
